(19) United States
(12) Patent Application Publication
(10) Pub. No.: US 2025/0224614 A1
(43) Pub. Date: Jul. 10, 2025

(54) IN-COUPLING META-GRATING, OUT-COUPLING META-GRATING, IMAGE COMBINER AND AR OPTICAL SYSTEM

(71) Applicant: SHENZHEN METALENX TECHNOLOGY CO.,LTD, Shenzhen (CN)

(72) Inventors: Rui ZHU, Shenzhen (CN); Jian ZHU, Shenzhen (CN); Chenglong HAO, Shenzhen (CN); Fengze TAN, Shenzhen (CN)

(73) Assignee: SHENZHEN METALENX TECHNOLOGY CO.,LTD, Shenzhen (CN)

(21) Appl. No.: 19/088,918

(22) Filed: Mar. 24, 2025

Related U.S. Application Data
(63) Continuation of application No. PCT/CN2023/123692, filed on Oct. 10, 2023.

(30) Foreign Application Priority Data
Oct. 28, 2022 (CN) 202211335945.X
Oct. 28, 2022 (CN) 202222859948.5

(51) Int. Cl. G02B 27/01; G02B 6/34

(52) U.S. Cl. CPC G02B 27/0172; G02B 6/34

(57) ABSTRACT

Provided is an in-coupling meta-grating and an out-coupling meta-grating, and the in-coupling meta-grating. The in-coupling meta-grating includes a plurality of in-coupling grating units, and the plurality of in-coupling grating units are arranged in a period; the in-coupling grating 5 units are configured to modulate a variety of incident target beams, and the variety of incident target beams are outgoing at corresponding target diffraction orders with the same outgoing angle; the variety of target beams have different wavelengths, and the target diffraction orders are the diffraction orders of the outgoing target beams modulated by the in-coupling meta-grating.

### CROSS REFERENCE TO RELATED APPLICATIONS

This application is a continuation of International Patent Application of PCT application serial No. PCT/CN2023/123692, field on Oct. 10, 2023, which claims the benefit of priority from Chinese Applications No. 202211335945.X and No. 202222859948.5, both field on Oct. 28, 2022. The content of the above applications, including any intervening amendments thereto, are incorporated herein by reference.

### TECHNICAL FIELD

The present application relates to the field of meta-grating, in particular to an in-coupling meta-grating, an out-coupling meta-grating, an image combiner and an AR optical system.

### BACKGROUND

A diffraction waveguide utilizes its diffraction grating to couple light beams within the waveguide, offering a wide range of applications. For instance, it can be employed in AR (Augmented Reality) glasses and various imaging scenarios. However, when the diffraction waveguide is applied to imaging, the diffraction grating (such as, a surface relief grating, SRG) makes the beams of different wavelengths (such as, RGB beams) with different diffraction angles. Because of the diffraction angles are different, after being transmitted with the total reflection in the waveguide, the incident angles are different when the beams are incident to the out-coupling grating. The numbers of total reflection of beams with different colors are different. Therefore, the lights of different colors in the guide of the number of the total reflection of the lights are different, thus resulting in the different positions of the proportion of three colors (RGB) being uneven. In this way, a rainbow effect is formed.

At present, the light of each color of RGB is processed by designing the multi-layer waveguide (such as, a three-layer waveguide) to alleviate the rainbow effect; the structural diagram of the three-layer waveguide is shown in FIG. 1. However, the multi-layer waveguide has a drawback of large volume, which results in increased weight, making it unsuitable for scenarios that require a thin and lightweight waveguide, such as AR glasses.

### SUMMARY

In view of the above technical problems, an in-coupling meta-grating, an out-coupling meta-grating, an image combiner and an AR optical system are provided according to embodiments of the present application, so as to overcome the problems in the related art.

In the first aspect, an in-coupling meta-grating is provided, and the in-coupling meta-grating includes: a plurality of in-coupling meta-grating units arranged in a period.

In the second aspect, an in-coupling meta-grating is provided. The in-coupling meta-grating includes: a plurality of in-coupling grating units; and the plurality of in-coupling grating units are arranged in a period;
the in-coupling grating units are configured to modulate a variety of incident target beams, and the variety of incident target beams are outgoing at corresponding target diffraction orders with the same outgoing angle;
the variety of target beams have different wavelengths, and the target diffraction orders are the diffraction orders of the outgoing target beams modulated by the in-coupling meta-grating.

In one embodiment, the plurality of in-coupling grating units are configured to modulate the variety of target beams with the same incident angles;
the variety of target beams corresponds to a variety of target diffraction orders.

In one embodiment, a period of the in-coupling meta-grating unit is configured to make a wavelength of the target beam negatively correlated with the corresponding target diffraction orders.

In one embodiment, the in-coupling grating unit is configured to modulate the variety of incident target beams, and the variety of incident beams are incident to the in-coupling meta-grating with a variety of incident angles.

In one embodiment, the variety of target diffraction orders comprises a first target diffraction order and a second target diffraction order;
a variety of first outgoing angles of the variety of target beams at the first target diffraction order are the same, and the variety of first outgoing angles of the variety of target beams at the second target diffraction order are the same;
the first outgoing angle and the second outgoing angle deflect to a variety of arrangement directions of the in-coupling grating unit.

In one embodiment, the in-coupling grating unit is configured to modulate the variety of target beams which are perpendicularly incident to the in-coupling meta-grating.

In one embodiment, the variety of target beams includes a red waveband beam, a green waveband beam and a blue waveband beam.

In one embodiment, the in-coupling grating unit includes a plurality of in-coupling nanostructures, and the plurality of in-coupling nanostructures are arranged in a line; at least a part of the in-coupling nanostructures are in different shapes.

In one embodiment, the in-coupling nanostructures are determined by maximizing the minimum diffraction efficiency, and the minimum diffraction efficiency is the lowest value among the diffraction efficiencies of all the target beams.

In the second aspect, an out-coupling meta-grating is provided. The out-coupling meta-grating includes: a plurality of out-coupling regions arranged in order along a preset direction, and the out-coupling regions comprise a plurality of out-coupling meta-grating units;
each out-coupling meta-grating unit is configured to couple out the variety of target beams, and the variety of target beams are incident to the out-coupling meta-grating unit at the same incident angle;
the variety of target beams propagate along the preset direction, and the diffraction efficiency of the plurality of out-coupling regions arranged in order increases progressively.

In one embodiment, the diffraction efficiency of the out-coupling regions satisfies:

$$eff ( n ) = \frac{1}{( N - n + 1 )} ;$$

wherein, eff(n) is the diffraction efficiency of a nth out-coupling region arranged along the preset direction, and N is a number of all the out-coupling regions.

In one embodiment, the out-coupling meta-grating unit comprises a plurality of out-coupling nanostructures arranged in a line along the length direction of the out-coupling meta-grating unit;
at least a part of the plurality of out-coupling nanostructures are in different shapes.

In one embodiment, the out-coupling nanostructures in each out-coupling region obtained by maximizing a target function, and the target function satisfies:

$${F}_{i} ( n ) = \{ \begin{matrix}min ( \frac{{\vert {t}_{{m}_{i}} ( n ) \vert}^{2}}{Eff ( n )} , \frac{{\vert {r}_{{0}_{i}} ( n ) \vert}^{2}}{1 - Eff ( n )} ) , n < N \\ {\vert {t}_{{m}_{i}} ( n ) \vert}^{2} , n = N\end{matrix} ;$$

wherein Fᵢ(n) is the diffraction efficiency of a nth out-coupling region for an ith target beam arranged along the preset direction; tₘ_{ᵢ}(n) is a diffraction light intensity of the nth out-coupling region for the ith target beam; r₀_{ᵢ}(n) is a reflective light intensity of the nth out-coupling region for the ith target beam; Eff(n) is a theoretical diffraction efficiency of a nth out-coupling region; N is a number of all out-coupling regions.

In the third aspect, an imaging combiner is provided. The imaging combiner comprises an in-coupling element, a waveguide, and an out-coupling element; the in-coupling element is located at an in-coupling end of the waveguide, and the out-coupling element is located at an out-coupling end of the waveguide;
the plurality of in-coupling meta-grating units of the in-coupling meta-grating are arranged along an first direction, and the plurality of out-coupling meta-grating units of the out-coupling meta-grating are arranged along the first direction;
wherein the first direction is from the in-coupling end of the waveguide to the out-coupling end of the waveguide.

In one embodiment, the in-coupling element is an in-coupling meta-grating claimed as claim 1, and the out-coupling element is the out-coupling meta-grating claimed as claim 10.

In one embodiment, the in-coupling element is an in-coupling meta-grating claimed as claim 1.

In one embodiment, the out-coupling element is the out-coupling meta-grating.

In the third aspect, an AR optical system is provided, wherein the AR optical system includes an imaging combiner claimed as claim 14, an image source and a relay lens group;
the image source is located at an incident side of the in-coupling element of the image combiner, and the image source is configured to emit at least three kinds of imaging beams of the target beams to the in-coupling element.

In one embodiment, the relay lens group is located on the optical path between the imaging combiner and the image source, and the relay lens group is configured to project the target beam as 1:1.

In one embodiment, the relay lens group is located on the optical path between the imaging combiner and the image source, and the relay lens group is configured to magnify and project to the imaging combiner.

In the application of the first aspect, and the in-coupling meta-grating includes: a plurality of in-coupling grating units; and the plurality of in-coupling grating units are arranged in a period; the in-coupling grating units are configured to modulate a variety of incident target beams at corresponding target diffraction orders, and the variety of target beams will be pass through the in-coupling grating units with the same outgoing angles; the variety of target beams have different wavelengths, and the target diffraction orders are the diffraction orders of the outgoing target beams modulated by the in-coupling meta-grating. For example, the target beams at different wavelengths are coupled out from the waveguide, so that the in-coupling target beams can be propagated together. In this way, the rainbow effect has been restrained. And the whole structure of the in-coupling meta-grating is a single-layer structure, which doesn't need the multiple-layer waveguide. And the in-coupling meta-grating has a thinner structure, which can be applied to the AR glasses and other scenarios with high requirements of volume and weight.

In order to make the above objectives, features and advantages of the invention more obvious and understandable, the better embodiments are given below and detailed in accordance with the attached drawings.

### BRIEF DESCRIPTION OF THE DRAWINGS

The present application may be better understood by reference to the description given below in combination with the drawings, where the same or similar markings are used in all the drawings to represent the same or similar components. The drawings are included in the specification along with the following detailed description and form part of the specification, and to further illustrate the preferred embodiments of the application and explain the principles and advantages of the application.

FIG. 1 shows a schematic diagram of the three-layer waveguide in the prior art.

FIG. 2 shows a schematic diagram of a top view of the in-coupling meta-grating provided by an embodiment of the present application.

FIG. 3 shows a schematic diagram of the first-side view structure of the in-coupling meta-grating provided by an embodiment of the present application.

FIG. 4 shows a schematic diagram of the second-side view structure of the in-coupling meta-grating provided by an embodiment of the present application.

FIG. 5 shows a schematic diagram of the third-side view structure of the in-coupling meta-grating provided by an embodiment of the present application.

FIG. 6 shows a schematic diagram of the fourth-side view structure of the in-coupling meta-grating provided by the embodiment of the present application.

FIG. 7 shows a schematic diagram of the fifth-side view structure of the in-coupling meta-grating provided by an embodiment of the present application.

FIG. 8 shows another schematic diagram of another top view of the in-coupling meta-grating provided by an embodiment of the present application.

FIG. 9 shows another schematic diagram of a top view of an in-coupling meta-grating provided by an embodiment of the present application.

FIG. 10 shows a schematic diagram of a top view of in-coupling meta-grating provided by an embodiment of the application.

FIG. 11 shows a schematic diagram of the side view of an in-coupling meta-grating provided by an embodiment of the application.

FIG. 12 shows another top-view structure of the in-coupling meta-grating provided by an embodiment of the present application.

FIG. 13 shows a schematic side view structure of an image combiner provided by an embodiment of the present application.

FIG. 14 shows a schematic diagram of the AR glasses provided by the embodiment of the present application.

FIG. 15 shows a schematic diagram of the in-coupling meta-grating unit provided by an embodiment of the present application.

FIG. 16 shows a far-field electromagnetic response diagram coupled to a meta-grating provided by an embodiment of the application.

FIG. 17 shows a schematic diagram of an out-coupled meta-grating unit provided by an embodiment of the present application.

FIG. 18 shows a far-field electromagnetic response diagram of the out-coupling meta-grating provided by an embodiment of the application.

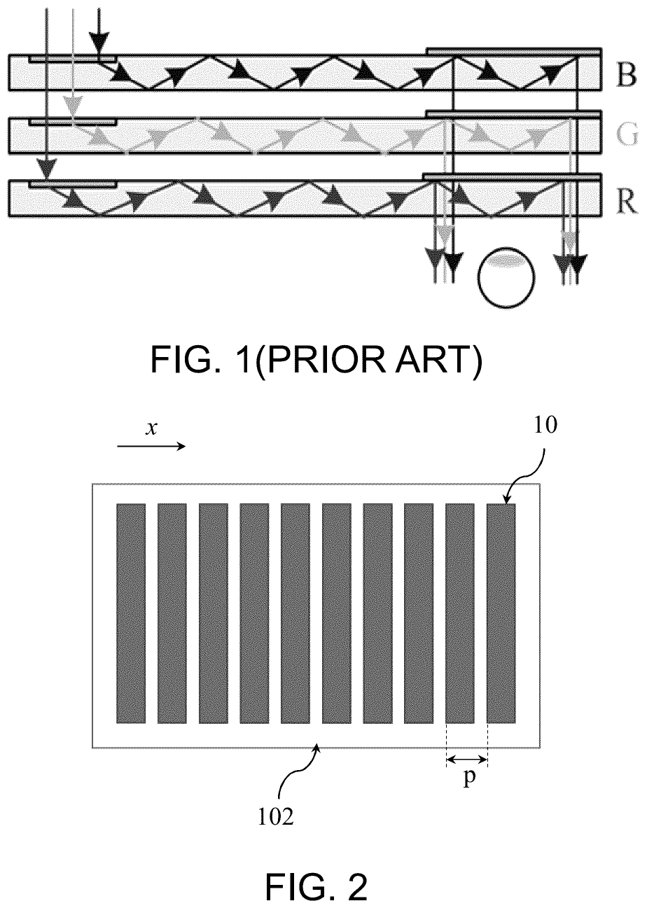

### DETAILED DESCRIPTION OF THE EMBODIMENTS

In the description of the present application, it needs to be understood that, the terms of “center”, “longitudinal”, “transverse”, “length”, “width”, “thickness”, “up”, “down”, “before”, “after”, “left”, “right”, “vertical”, “order”, “top”, “bottom”, “inside”, “outside”, “clockwise”, “counterclockwise” indicate the orientation or position relationship based on the orientation or position relationship shown in the attached drawings, only to facilitate the description of the present application and to simplify the description, rather than indicating or implying that the device or element must have a specific orientation, be constructed and operate in a specific orientation. Therefore, it cannot be understood as a limitation on the present application.

Moreover, the terms of “first” and “second” are used only for descriptive purposes and cannot be understood as indicating or implying relative importance or implicitly indicating the number of technical characteristics indicated. Thus, the first or second may explicitly or implicitly include one or more features. In the description of the application, the meaning of “multiple” is two or more, unless otherwise specified and specific.

In the present application, unless otherwise clearly defined and defined, the terms “installation”, “connected”, or “fixed” should be generalized, e. g., fixed or removable or integrated, mechanically or electronically, directly or indirectly, or an internal connection of the two elements. For those skilled in the art, the specific meaning of the term in the application may be understood in the light of specific circumstances.

An in-coupling meta-grating is provided by the present application, and it is a meta-grating that can realize the in-coupling function. As shown in FIG. 2, the in-coupling meta-grating includes the plurality of in-coupling meta-grating units 10, and the plurality of in-coupling meta-grating units 10 are arranged in a period. The plurality of in-coupling meta-grating units 10 are configured to modulate a variety of incident target beams, and the variety of incident target beams are outgoing at corresponding target diffraction orders with the same outgoing angle; the variety of target beams have different wavelengths, and the target diffraction orders are the diffraction orders of the outgoing target beams modulated by the in-coupling meta-grating.

In the present application, the in-coupling meta-grating includes a plurality of in-coupling meta-grating units 10, which are arranged in a period. For example, the plurality of in-coupling meta-grating units 10 may be arranged in a period along the preset direction. As shown in FIG. 2, the striped in-coupling meta-grating units 10 are arranged along a direction that is perpendicular to the x direction, and the plurality of in-coupling meta-grating units 10 are arranged along the x direction. As shown in FIG. 2, the plurality of in-coupling meta-grating units 10 are arranged on the substrate 102 of the in-coupling meta-grating, and the substrate 102 is configured to fix and support the in-coupling meta-grating units 10.

Moreover, the in-coupling meta-grating units 10 are configured to modulate the incident beams of different wavelengths. In the present embodiment, the incident beams that are incident to the in-coupling meta-grating are called target beams, and each target beam corresponds to a wavelength. Under the action of the in-coupling meta-grating unit 10, the in-coupling meta-grating can modulate the diffraction effect of each target beam so that each target beam can be emitted according to the diffraction order modulated by the in-coupling meta-grating unit 10. In the present application, the diffraction orders are recorded as the target diffraction orders. When each target beam is outgoing according to the corresponding target diffraction order, the outgoing angles of different target beams are the same by designing the diffraction effect of the in-coupling meta-grating unit 10 for different kinds of target beams. For example, the target diffraction orders of different kinds of target beams are different, therefore the in-coupling meta-grating unit 10 can realize multiple outgoing target beams at the same outgoing angles.

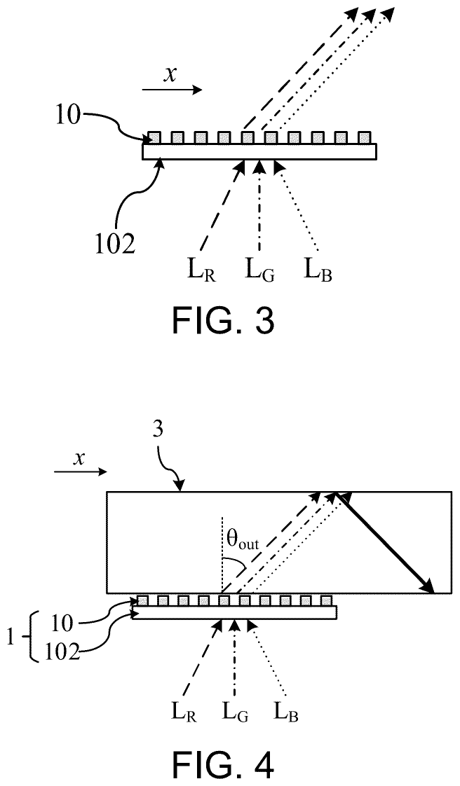

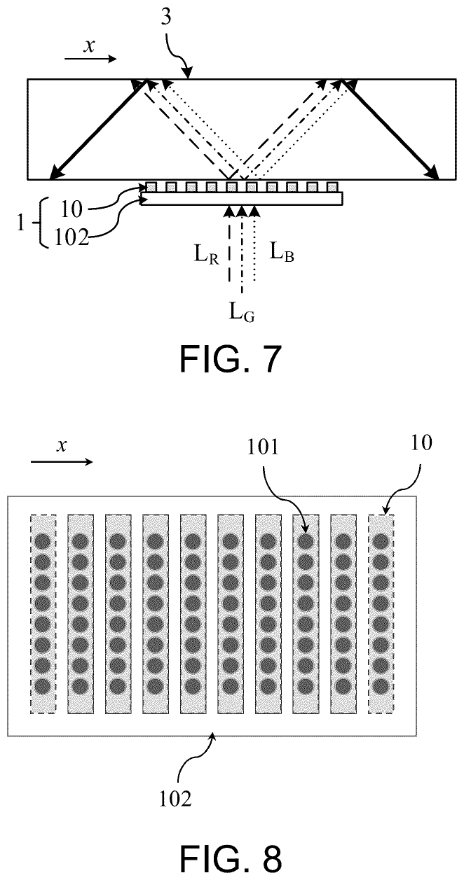

For example, the in-coupling meta-grating is configured to image, that is, the incident beams of the in-coupling meta-grating at least include a red waveband beam, a green waveband beam and a blue waveband beam. As shown in FIG. 3, L_{R} represents the red waveband beam, L_{G} represents the green waveband beam, and L_{B} represents the blue waveband beam. After L_{R}, L_{G} and L_{B} are diffracted by the in-coupling meta-grating, L_{R}, L_{G} and L_{B} may be outgoing at the same angle, that is, the target beams at the three wavebands have the same outgoing angles. To illustrate that target beams of different wavelengths will pass through the in-coupling meta-grating at the same angle, FIG. 3 shows the beams at red, green and blue wavebands in the form of intervals. Those skilled in this field can understand that these beams can be overlapping, and subsequent FIG. 4˜FIG. 7 are similar to FIG. 3, which will not be described later.

The in-coupling meta-grating provided by the present embodiment includes a plurality of in-coupling grating units 10, and the plurality of in-coupling grating units 10 are arranged in a period. The in-coupling grating units 10 are configured to modulate a variety of target beams, and the variety of target beams have different wavelengths, and the different target diffraction orders of the outgoing target beams are modulated by the in-coupling meta-grating. In this way, different target beams will pass through the in-coupling grating units 10 with the same outgoing angle after different target beams are incident to the in-coupling meta-grating unit 10. The in-coupling meta-grating can couple in the target beams at different wavelengths at the same angle. For example, the target beams of different wavelengths will be coupled in the waveguide at the same angle, so that the in-coupling target beams with different wavelengths will be propagated together. In this way, the rainbow effect is depressed effectively. Moreover, the whole in-coupling meta-grating is a single-layer structure. Thus, there is no need to establish a multi-layer waveguide, allowing the in-coupling meta-grating to have a thinner structure. Consequently, the in-coupling meta-grating can be utilized in AR glasses or other scenarios where volume and weight are critical constraints.

Optionally, since the period of the in-coupling meta-grating unit will affect the relationship between the incident angle, outgoing angle and diffraction order, the embodiment controls the incident beam at the corresponding incident angle by designing a suitable period. For example, the usual form of the meta-grating may be (nₒᵤₜ sin θₒᵤₜ−n_{inc} sin θ_{inc})/λᵢ=mᵢ/p. λᵢ is a working wavelength of the meta-grating, for example, the working wavelength of the meta-grating may be a wavelength of an iₜₕ target beam; n_{inc} is a reflective index of the outer environment and nₒᵤₜ is a reflective index of the meta-grating; θ_{inc} is an incident angle of the incident beam for the meta-grating and θₒᵤₜ is an outgoing angle of the in-coupling beam for the meta-grating. For example, θₒᵤₜ is an outgoing angle representing the outgoing angle that the beams are coupled inside the waveguide. In general, θₒᵤₜ is greater than the critical angle for the total internal reflection of the waveguide. mᵢ is a diffraction order. For example, the target diffraction order of the iₜₕ target beam is an integer. And p is the period of the meta-grating, and the period of the in-coupling meta-grating unit 10 can be seen in FIG. 2.

The in-coupling meta-grating allows the target diffraction order corresponding to a variety of target beams. For example, all the target beams correspond to the one target diffraction order. For example, the target diffraction order of each target beam is +2 diffraction order. In the present application, the different target beams will pass through the in-coupling meta-grating with the same angle by setting a reasonable period p, the incident angle and the outgoing angle. And at least a part of the diffraction orders of the different target beams, so that the parameters of the in-coupling meta-grating units 10 (such as, a period of the in-coupling meta-grating unit 10) can be determined fast and easily.

The incident light of the in-coupling meta-grating includes a red waveband beam L_{R}, a green waveband beam L_{G}, and a blue waveband beam L_{B}. As shown in FIG. 4, the in-coupling meta-grating 1 is located at the in-coupling end of the waveguide 3, and the in-coupling meta-grating 1 is configured to couple the three beams (L_{R}, L_{G}, L_{B}) in the waveguide 3, so that the three waveband beams can propagate along the waveguide 3. As shown in FIG. 4, the three waveband beams will be incident to the in-coupling meta-grating 1, and with the modulation of the in-coupling meta-grating 1 the three waveband beams will be coupled in the waveguide 3 with the same outgoing angle of θout. If the incident angles of the three waveband beams are θ_{R}, θ_{G}, θ_{B}, respectively, the usual form based on the meta-grating satisfies the formula (1):

$$\{ \begin{matrix}\frac{( {n}_{out} sin {θ}_{out} - {n}_{inc} sin {θ}_{R} )}{{λ}_{R}} = \frac{{m}_{R}}{p} \\ \frac{( {n}_{out} sin {θ}_{out} - {n}_{inc} sin {θ}_{G} )}{{λ}_{G}} = \frac{{m}_{G}}{p} \\ \frac{( {n}_{out} sin {θ}_{out} - {n}_{inc} sin {θ}_{B} )}{{λ}_{B}} = \frac{{m}_{B}}{p}\end{matrix} \qquad ( 1 )$$

Wherein, λ_{R}, λ_{G}, λ_{B} are wavelengths of red waveband beam, green waveband beam and blue waveband beam, respectively. For example, λ_{R}≈720 nm, λ_{G}≈540 nm, λ_{B}≈432 nm. m_{R}, m_{G}, m_{B} are target diffraction orders corresponding to the target red waveband beam, target green waveband beam and target blue waveband beam, respectively. p is the period of the in-coupling mete-grating unit 10. Moreover, the three kinds of target diffraction orders may be the same, that is, m_{R}=m_{G}=m_{B}. Based on the formula (1), it can be understood that the incident angle is correlated with the period. When the period p is determined, the incident angles required by the red waveband beam, green waveband beam and blue waveband beam can be calculated easily. In this way, the red waveband beam, green waveband beam and blue waveband beam can be incident to the in-coupling meta-grating 1 with corresponding incident angles, so that those beams will pass through the in-coupling meta-grating 1 with the same angle.

In one embodiment, the traditional grating mainly uses the same diffraction order (which usually is +1 diffraction order or −1 diffraction order). When different beams of different wavelengths are incident to the traditional diffraction grating with the same incident angle, for the one diffraction order, different beams at different wavelengths have different diffraction angles. That is, different beams at different wavelengths have different outgoing angles, which will cause the rainbow effect. In the present embodiment, a variety of target beams will pass through the in-coupling meta-grating unit 10 at the same outgoing angle by diffracting the target beams at different wavelengths at different target diffraction orders. Specifically, the in-coupling meta-grating unit 10 is configured to modulate a variety of target beams at the same incident angle; and the different target beams correspond to different target diffraction orders.

Based on the general form of a diffraction grating, when the target beam is incident to the meta-grating at the same incident angle, the wavelength of the target beam corresponds to the target diffraction order one to one. Due to the different wavelengths of different target beams, the target diffraction orders corresponding to different target beams are also different. Specifically, the embodiment of the present application makes the different target beams emitted at the same outgoing angle under the constraint that the integer diffraction order by setting a suitable period p. At this moment, the period of the in-coupling meta-grating unit makes a wavelength of the target beam negatively correlated with the corresponding target diffraction orders.

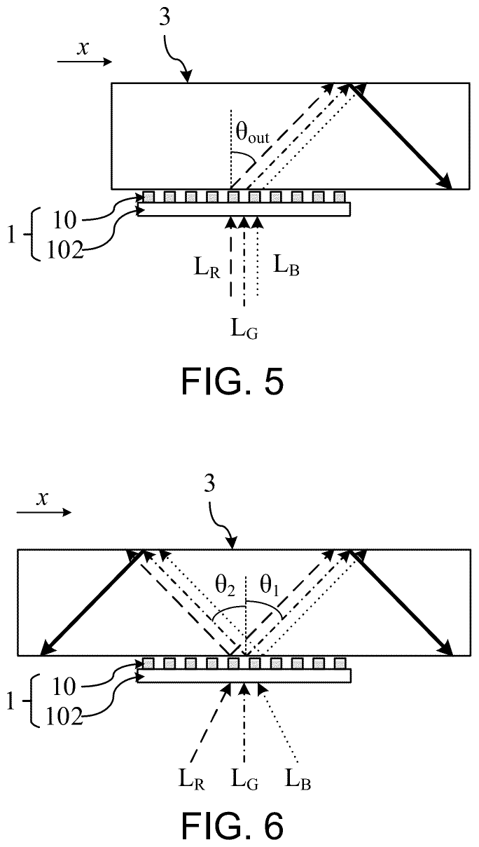

In one embodiment, the incident beams of the in-coupling meta-grating includes the red waveband beam L_{R}, the green waveband beam L_{G} and the blue waveband beam L_{B}. As shown in FIG. 5, the in-coupling meta-grating 1 is located at the in-coupling end of the waveguide 3, and the in-coupling meta-grating 1 is configured to couple the three waveband beams in the waveguide 3, so that the three waveband beams can propagate along the waveguide 3. As shown in FIG. 5, three waveband beams are incident to the in-coupling meta-grating 1 at the same incident angle. If the incident angles of the red, green and blue waveband beams are θ_{R}, θ_{G} and θ_{B}, respectively, that is, θ_{R}=ƒ_{G}=θ_{B}. Moreover, with the modulation of the in-coupling meta-grating 1, the three waveband beams are coupled in the waveguide 3 at the same outgoing angle θₒᵤₜ. Based on the formula (1), the wavelength of the target beam is negatively correlated with the corresponding target diffraction order. That is, the product of the wavelength of the target beam and the target diffraction order is a constant value:

$$( {n}_{out} sin {0}_{out} - {n}_{inc} sin {θ}_{inc} ) p = {λ}_{i} \times {m}_{i} ;$$

wherein λᵢ is a wavelength of an iₜₕ kind of the target beam; θ_{inc} is an incident angle; mᵢ is the target diffraction efficiency of the iₜₕ target beam.

Optionally, the in-coupling meta-grating will diffract a target beam at two different diffraction orders, thus diffracting the target beam to two different positions. In this way, the target beam coupled in the in-coupling meta-grating can be received at different locations. For example, the in-coupling meta-grating enables binocular imaging in the case of a single image source. In the embodiment of the present application, the target diffraction order includes the first target diffraction order and the second target diffraction order. Moreover, the first outgoing angles of the first target diffraction order of the different target beams are the same, and the second outgoing angle corresponding to the second target diffraction order of the different target beams are the same; the first outgoing angle is different from the arrangement direction of the second in-coupling meta-grating unit 10.

In the embodiment of the present application, the in-coupling meta-grating can diffract a part of the target beam according to the first target diffraction order, and the outgoing angle is the first outgoing angle. The outgoing angle of in-coupling meta-grating may be the first outgoing angle; the in-coupling meta-grating may diffract other parts of the target beam according to the second target diffraction order, and the outgoing angle is the second outgoing angle. Moreover, the first angle of all the target beams is the same, and the second angles of all the target beams are the same.

The first outgoing angle and the second outgoing angle are different, that is, all the target beams may be incident to two different locations in overlapping ways. Moreover, the first outgoing angle and the second outgoing angle deflect to different arrangement directions. In the present embodiment, the in-coupling meta-grating unit 10 is arranged in a period, the arrangement essentially corresponds to two arrangement directions. Correspondingly, the in-coupling meta-grating unit 10 reflects the target beam towards different arrangement directions, that is, the two outgoing angles (the first outgoing angle and the second outgoing angle) of the target beam towards different arrangement directions. For example, as shown in FIG. 2 and FIG. 6, the plurality of in-coupling meta-grating units 10 are arranged along the x direction (in other words, are arranged along the +x direction), and the plurality of in-coupling meta-grating units 10 are arranged along the −x direction. Correspondingly, as shown in FIG. 6, a part of the target beam passes through the in-coupling meta-grating 10 with the first outgoing angle of θ₁, and the first outgoing angle of θ₁ reflects to the +x direction; the other part of the target beam passes through the in-coupling meta-grating unit 10 with the second outgoing angle of θ₂ to −x direction, so that the target beam may be transmitted to both sides of the in-coupling meta-grating. In this way, the binocular imaging can be achieved when there is only a single image source.

Optionally, as shown in FIG. 7, the in-coupling meta-grating unit 10 is configured to modulate the variety of perpendicularly incident target beams. At this moment, for a certain target beam, the in-coupling meta-grating unit 10 has a positive or a negative relationship on the diffraction order of the target beam; for example, the first target diffraction order is +m, and the second target diffraction order is −m.

Based on any above embodiment, as shown in FIG. 8, the in-coupling meta-grating unit 10 includes the plurality of in-coupling nanostructures 101 of the in-coupling meta-grating units 10 arranged in a line. Moreover, at least part of the in-coupling nanostructures 101 are in different shapes. The in-coupling nanostructures 101 in FIG. 8 are represented as circular, which doesn't show the different shapes of the in-coupling nanostructures 101.

The whole shape of the in-coupling meta-grating 10 is a striped structure, and the in-coupling meta-grating unit 10 includes a plurality of in-coupling meta-grating nanostructures 101, and the plurality of the in-coupling meta-grating nanostructures 101 in the in-coupling meta-grating 10 in the are arranged in a line. As shown in FIG. 8, the meta-grating unit 10 is a striped structure along the x direction. Correspondingly, the plurality of in-coupling nanostructures 101 are arranged in a line along the x direction. Optionally, the in-coupling meta-grating 10 may include the plurality of in-coupling meta-grating nanostructures 101, that is, the plurality of in-coupling meta-grating units 10. The in-coupling meta-grating nanostructures 101 will form a striped in-coupling meta-grating unit 10.

In one embodiment, all the in-coupling meta-grating units 10 are the same. However, in the in-coupling meta-grating unit 10, at least a part of the in-coupling meta-grating nanostructures 101 are in different shapes. For example, the in-coupling meta-grating nanostructures of the in-coupling meta-grating unit 10 are in different shapes. Optionally, the shapes of the in-coupling meta-grating nanostructures 101 are polarization-dependent. For example, the in-coupling nanostructure 101 has two orthogonal symmetric surfaces, and the in-coupling nanostructure 101 is symmetric between the two orthogonal symmetric surfaces. For example, each in-coupling meta-grating nanostructure 101 has a symmetry axis, and the coupled nanostructure 101 rotates 90° along the symmetry axis without deforming. For example, the shape of the in-coupling nanostructures 101 includes at least one of the cylindrical, circular, square ring, and cruciform columns.

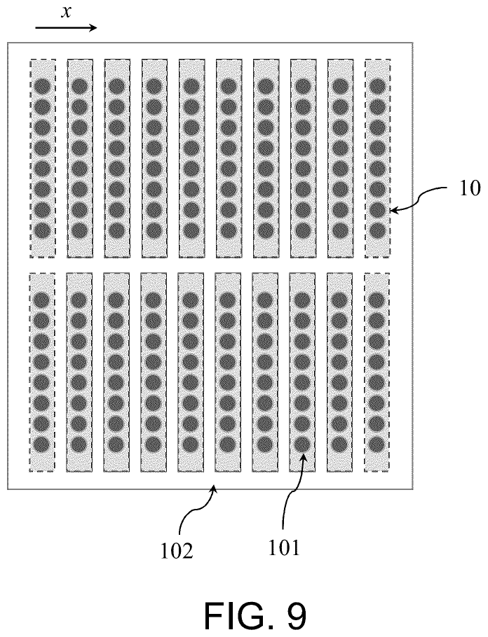

As shown in FIG. 8, the in-coupling meta-grating may include a row of in-coupling meta-grating units 10; or as shown in FIG. 9, the in-coupling meta-grating may also include multiple rows of in-coupling meta-grating units 10, and each row of in-coupling meta-grating units 10 is arranged along the x direction.

In order to make the target beams at different wavelengths pass through the in-coupling meta-grating 10 according to specific diffraction orders (that is, the target diffraction order); or as shown in FIG. 9, the in-coupling meta-grating may only include a row of in-coupling meta-grating units 10, and each row of in-coupling meta-grating units 10 is arranged along the x direction.

It is challenging to emit the target beams at specific diffraction orders (i.e., the target diffraction orders) if solely the parameters of the in-coupling meta-grating unit 10 are designed (for instance, the period of the in-coupling meta-grating unit 10 is p), as this will result in the in-coupling meta-grating being unable to fulfill the required function. For example, it may cause the in-coupling meta-grating to have a lower diffraction efficiency. Optionally, in the present embodiment, the in-coupling meta-grating 10 is designed by the in-coupling nanostructures 101 with the different shapes, thus the design degree of freedom of the nanostructure shape can be introduced, making the in-coupling meta-grating unit 10 more possible to enable the ability of the target beam at different wavelengths passing through the in-coupling meta-grating unit 10 at the same outgoing angle.

Optionally, when designing the in-coupling meta-grating unit 10, the diffraction efficiency can be a target, so that the any kind of target beam with a higher diffraction efficiency will pass through the determined in-coupling meta-grating unit 10. Specifically, the in-coupling nanostructures 101 is the nanostructures determined by maximizing the smallest diffraction efficiency, and the smallest efficiency diffraction is the smallest value of all the diffraction efficiencies of all the target beams.

In the present embodiment, when designing the in-coupling meta-grating unit 10, at least a part of the nanostructures with different shapes may form a candidate grating unit. And the diffraction efficiency of the candidate grating unit for each target beam can be determined. For example, the electric field intensity of the target beam as it passes through the candidate grating unit can be decomposed into plane waves with different Fourier orders. Consequently, the electric field intensity of the target diffraction order of the beam can be determined, and the diffraction efficiency of the candidate grating unit on the target beam can be expressed in terms of the electric field intensity.

The embodiment of the present application determines the minimum diffraction efficiency of all target beam (that is, the minimum diffraction efficiency) and by maximizing the minimum diffraction efficiency, which can be obtained as the required in-coupling meta-grating unit 10. The minimum diffraction efficiency is the lowest value among the diffraction efficiencies of all the target beams. For example, the coupled grating unit 10 needs to modulate the target beams of the red, green, and blue waveband, and the diffraction efficiency of each target beam is respectively: F_{R}, F_{G}, F_{B}. The optimization target F can be expressed as F=min (F_{R}, F_{G}, F_{B}). Finally, the desired in-coupling meta-grating unit 10 can be designed with high diffraction efficiency by maximizing this optimization target F.

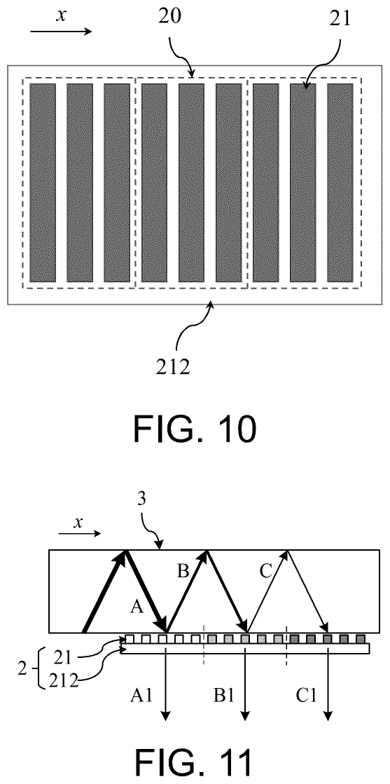

The in-coupling meta-grating described in the above embodiment allows target beams of various wavelengths to be coupled in at the same outgoing angle, resulting in these target beams overlapping with each other. Correspondingly, the embodiment of the present application will provide an out-coupling meta-grating, and the out-coupling meta-grating includes: a plurality of out-coupling regions arranged in order along a preset direction. The out-coupling regions include a plurality of out-coupling meta-grating units; each out-coupling meta-grating unit is configured to couple out the variety of target beams, and the variety of target beams are incident to the out-coupling meta-grating unit at the same incident angle; the variety of target beams propagate along the preset direction, and the diffraction efficiency of the plurality of out-coupling regions arranged in order increases progressively. As shown in FIG. 10, the plurality of out-coupling meta-grating units 21 are arranged along the x direction; and for each out-coupling region 20, and the substrate 212 is configured to support and fix the plurality of out-coupling meta-grating units 21.

As shown in FIG. 10, the x direction represents the preset direction, and the plurality of out-coupling meta-grating regions 20 are arranged along the x direction in order. And each out-coupling meta-grating region 20 includes the plurality of out-coupling meta-grating units 21. And the plurality of out-coupling meta-grating units 21 are arranged along the x direction. FIG. 10 shows an out-coupling meta-grating including three out-coupling meta-grating regions 20. And each out-coupling meta-grating region 20 includes three out-coupling meta-grating units 21. It is understood by those skilled in the art that the out-coupling region 20 is a part of the out-coupling grating, but it doesn't mean that the plurality of out-coupling regions 20 need to be divided, that is, the out-coupling grating is still an integral structure. For example, as shown in FIG. 10, the out-coupling meta-grating contains nine out-coupling meta-grating units 21, which may divide the nine out-coupling meta-grating units 21 in the x direction into three parts. And each out-coupling meta-grating unit 21 corresponds to an out-coupling region 20.

The out-coupling meta-grating is configured to couple a target beam of different wavelengths propagating along the x direction out, and each target beam is incident at the same incident angle; where in the x-direction, the diffraction efficiency of the out-coupling region 20 increases progressively. The target beam propagates along the x direction, and the diffraction efficiency of the out-coupling regions 20 increases progressively. Each target beam is incident to the out-coupling meta-grating with the same incident angle. In the x direction, the diffraction efficiency of the out-coupling region 20 increases progressively. That is, the far left out-coupling region 20 of FIG. 10 has the least diffraction efficiency, and the middle out-coupling region 20 has a greater diffraction efficiency, and the far right out-coupling region 20 has the maximum diffraction efficiency.

In one embodiment, the out-coupling meta-grating is configured to couple the beams out, which is configured to couple the beams propagating along the waveguide out. As shown in FIG. 11, the waveguide 3 is set along the x direction, and the target beam of different wavelengths propagates the target beams along the waveguide 3 with the reflection of the waveguide 3 (for example, total reflection), so that the target beam propagates along the x direction. Moreover, the out-coupling meta-grating 2 is set on the out-coupling end of the waveguide 3, and the out-coupling unit 21 of the out-coupling meta-grating 2 is arranged along x direction. FIG. 11 shows the boundaries of the adjacent two out-coupling regions 20 in dashed lines and shows the out-coupling meta-grating units 21 in the different out-coupling regions 20 in different gray scales. The beam A propagates along the waveguide 3 (the beam A includes the plurality of beams of different wavelengths), which can be incident to the far right of the out-coupling meta-grating region 20. Because the diffraction efficiency of the out-coupling region 20 is the smallest, a little part of the beam A can be coupled out. That is, the beam A1 is coupled out, and other parts of the beam A will propagate along the waveguide 3. That is, the beam B continues to propagate along the waveguide 3. The beam B may be incident to the out-coupling region 20 in the middle of the out-coupling meta-grating. Although the light intensity of the beam B is lower than the light intensity of the beam A (because a part of the beam A is coupled out), the middle in the out-coupling meta-grating has a higher diffraction efficiency, the out-coupling region still can be coupled beam B1 out. Other beam C (that is, the rest parts of the beam B) still can propagate along the waveguide 3, and the beam C is incident to the far right side of the out-coupling region 20. Because the far right side of the out-coupling region 20 has the highest diffraction efficiency, the far right side of the out-coupling region 20 will couple the beam C1 with the moderate light intensity out. For example, the diffraction efficiency of the far right side of the out-coupling region 20 is 1, and the diffraction efficiency of the far right side of the out-coupling region 20 will couple all the beams out. The embodiment of the present application uses a number of out-coupling regions 20 with gradually increasing diffraction efficiency, and the distribution of the light intensity on the outgoing side of the out-coupled meta-grating is relatively uniform.

Optionally, the diffraction efficiency of the out-coupling region 20 satisfies:

$$eff ( n ) = \frac{1}{( N - n + 1 )} ; \qquad ( 3 )$$

eff(n) is the diffraction efficiency of an n^{th} out-coupling region arranged along the preset direction, and N is a number of all the out-coupling regions.

In one embodiment, with n representing the sequence number of the coupling region 20 arranged in the preset direction, the diffraction efficiency of each of the coupling region 20 can be determined based on the above equation (3). For example, as shown in FIG. 11, the out-coupling meta-grating includes three out-coupling regions 20, that is N=3. Correspondingly, the number of three out-coupling meta-grating is 1, 2, 3 in order from left to right of FIG. 11, which has a diffraction efficiency of ⅓, ½ and 1. In this situation, the light intensity of the beam coupled by each out-coupling region 20 is basically the same, that is, the light intensity of beam A1, beam B1 and beam C1 is basically the same. Regardless of the loss, the light intensity of beam A1, beam B1 and beam C1 are ⅓ of the incident beam A.

It should be noted that the diffraction efficiency eff(n) refers to the actual nₜₕ out-coupling region 20. Due to the process, the actual eff(n) of the nₜₕ out-coupling region 20 doesn't fully satisfy the above equation (3); in the present embodiment, within the error range, as long as the diffraction efficiency of the nₜₕ out-coupling region 20 has a little difference of

$$\frac{1}{( N - n + 1 )} .$$

For example, when

$$eff ( n ) \approx \frac{1}{( N - n + 1 )} ,$$

the diffraction efficiency of the nₜₕ out-coupling region 20 can be considered to satisfy the above equation (3).

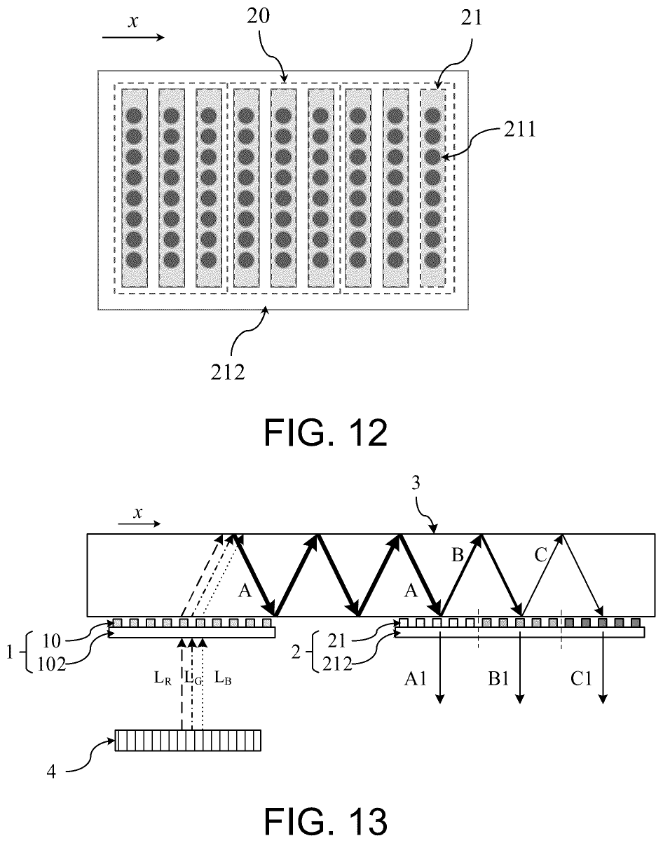

Based on any of the above embodiments, as shown in FIG. 12, the out-coupling meta-grating unit 21 includes a plurality of out-coupling nanostructures 211 arranged along the shapes of the out-coupling meta-grating unit 21; and at least different shapes of the out-coupling nanostructures 211. FIG. 12 doesn't show the different shapes of the out-coupling nanostructures 211.

Similar to the in-coupling meta-grating unit 10, the whole shape of the out-coupling meta-grating unit 10 is a striped structure. The out-coupling meta-grating unit 21 may include the plurality of out-coupling nanostructures 211, and the out-coupling nanostructures 211 are arranged in a line. As shown in FIG. 12, the out-coupling meta-grating unit 21 is a striped structure perpendicular to the x direction. Correspondingly, the out-coupling meta-grating unit 21 may include a plurality of out-coupling nanostructures 211. In other words, these out-coupling nanostructures 211 collectively form the out-coupling unit 21, and when arranged in a line, they constitute the out-coupling meta-grating unit 21.

In one embodiment, all the out-coupling meta-grating units 21 of the out-coupling region 20 are the same, but in the out-coupling meta-grating unit 21 at least part of the out-coupling nanostructures 211 are in different shapes. For example, the shapes of the nanostructures of the out-coupling meta-grating unit 21 are different. Optionally, the shapes of the out-coupling nanostructures 211 are polarization-independent. For example, the out-coupling nanostructures 211 have two symmetric surfaces of the orthogonal, and each part divided by these two symmetric faces is the same as the out-coupling nanostructures 211 exactly. For example, the out-coupling nanostructures 211 have a symmetry axis. The out-coupling nanostructure 211 can rotate 90° along the symmetry axis with an unchanged shape. For example, the shape of the out-coupling nanostructure 211 includes at least one of the cylindrical, cylindrical ring, square ring column, and cruciform column.

Optionally, as mentioned above, the out-coupling meta-grating unit 21 of the different out-coupling regions 20 may have varying diffraction efficiencies for the target beam, yet each out-coupling region 20 maintains the same diffraction efficiency for target beams across different wavelengths. In addition, the out-coupling meta-grating unit 21 is configured to modulate the different target beams, so that the different target beams will pass through the out-coupling meta-grating unit 21 with the same outgoing angle. And the target beams are incident to the out-coupling meta-grating unit 21 with the same incident angle. That is, the out-coupling meta-grating unit 21 also controls the diffraction orders with different wavelengths. To emit the target beams with different wavelengths according to the specific diffraction efficiency, the parameters of the out-coupling meta-grating unit 21 are designed (for example, the period of the out-coupling meta-grating unit 21), which is easy to cause the out-coupling meta-grating can't realize the required functions. For example, it may cause a part of the diffraction efficiency of the out-coupling region 20 will not satisfy the requirements of the diffraction efficiency for a certain wavelength. Optionally, in the present embodiment, the out-coupling meta-grating unit 21 may be designed according to different nanostructures (that is, the out-coupling nanostructures 211) with different shapes. The degree of design freedom increases by introducing the nanostructure shapes, which can make the out-coupling meta-grating unit 21 has more capacity. In this way, the out-coupling meta-grating unit 21 satisfied the requirements can be designed, that is, the variety of target beams can pass through the out-coupling meta-grating unit 21 at different wavelengths.

Optionally, to ensure the diffraction efficiency of each out-coupling region 20 satisfies more requirements, for example, the diffraction efficiency of each out-coupling region 20 satisfies formula (3). In the present embodiment, there is a target function, and whether the diffraction efficiency of each out-coupling region 20 satisfies the requirements is determined by maximizing the target function to optimize the out-coupling nanostructures 211. The target function satisfies:

$${F}_{i} ( n ) = \{ \begin{matrix}min ( \frac{{\vert {t}_{{m}_{i}} ( n ) \vert}^{2}}{Eff ( n )} , \frac{{\vert {r}_{{0}_{i}} ( n ) \vert}^{2}}{1 - Eff ( n )} ) , n < N \\ {\vert {t}_{{m}_{i}} ( n ) \vert}^{2} , n = N\end{matrix} ; \qquad ( 4 )$$

Fᵢ(n) is the diffraction efficiency of a n^{th} out-coupling region for an iₜₕ target beam arranged along the preset direction; tₘ_{ᵢ}(n) is a diffraction light intensity of the nth out-coupling region for the iₜₕ target beam; r₀_{ᵢ}(n) is a reflective light intensity of the nth out-coupling region for the iₜₕ target beam; Eff(n) is a theoretical diffraction efficiency of a nth out-coupling region; N is a number of all out-coupling regions 20.

In one embodiment, the greater the theoretical diffraction efficiency Eff(n) of the n^{th} out-coupling region 20, the greater the diffraction light intensity tₘ_{ᵢ}(n) of the n^{th} out-coupling region 20 is. For the last out-coupling region 20 (that is, n=N), the diffraction light intensity tₘ_{ᵢ}(N) is regarded as an optimal target directly, so that the real diffraction efficiency of the last out-coupling region 20 is close to 1. For other out-coupling region 20, as shown in formula (4), a difference between the theoretical diffraction efficiency Eff(n) and the real diffraction efficiency eff(n) is determined based on the theoretical diffraction efficiency Eff(n). In one embodiment, the smaller value of

$$\frac{{\vert {t}_{{m}_{i}} ( n ) \vert}^{2}}{Eff ( n )} and \frac{{\vert {r}_{{0}_{i}} ( n ) \vert}^{2}}{1 - Eff ( n )}$$

is used to represent the difference between the theoretical diffraction efficiency Eff(n) and the real diffraction efficiency eff(n). When the greater the difference between the theoretical diffraction efficiency Eff(n) and the real diffraction efficiency eff(n) is, the real diffraction efficiency eff(n) is closer to the theoretical diffraction efficiency Eff(n). The real diffraction efficiency eff(n) of the n^{th} out-coupling region 20 is equal to the theoretical diffraction efficiency Eff(n) of the nₜₕ out-coupling region 20 by maximizing Fᵢ(n).

The theoretical diffraction efficiency Eff(n) can be determined previously. For example, the out-coupling meta-grating includes three out-coupling regions 20. That is, N=3. The theoretical diffraction efficiency Eff(n) of three out-coupling regions 20 is: ⅓, ½, 1 in order. Those skilled in the present technology should understand that Eff(n) represents the theoretical diffraction efficiency Eff(n) of the nₜₕ out-coupling region 20, which has a little difference with the real diffraction efficiency eff(n) of the nₜₕ out-coupling region 20.

An out-coupling meta-grating is provided by the present application, which includes the plurality of out-coupling region 20 arranged along the preset direction, and the diffraction efficiency of the out-coupling region 20 in order increases progressively. When the whole target beam propagates along the preset direction and is incident to the out-coupling meta-grating, the target beam can be coupled out uniformly. Thus, the optical pupil replication is realized, which can increase the range of the eyebox. And the nanostructures are optimized by above optimal target, and the required nanostructures 211 of each out-coupling region 20 are determined, so that the diffraction efficiency of each out-coupling region 20 can satisfy the requirements.

Optionally, an imaging combiner is provided by the present embodiment, as shown in FIG. 13, the imaging combiner includes an in-coupling element, a waveguide 3, and an out-coupling element 3. The in-coupling element may be the in-coupling meta-grating 1 as mentioned above, and/or the out-coupling element may be the out-coupling meta-grating 2 as mentioned above. As shown in FIG. 13, the in-coupling element is located at an in-coupling end of the waveguide 3, and the out-coupling element is located at an out-coupling end of the waveguide 3. The plurality of in-coupling meta-grating units of the in-coupling meta-grating are arranged along the first direction, and the plurality of out-coupling meta-grating units of the out-coupling meta-grating are arranged along the first direction. The first direction is from the in-coupling end of the waveguide 3 to the out-coupling end of the waveguide 3.

In one embodiment, the plurality of in-coupling grating units 10 of the in-coupling meta-grating 1 and the out-coupling meta-grating units 21 in the out-coupling meta-grating 2 are all arranged along the first direction within the optical waveguide 3, that is, the waveguide 3 is set along the direction. As shown in FIG. 13, the in-coupling end of the waveguide 3 is located at the lower surface of the left end of the waveguide 3, and the out-coupling end of the waveguide 3 is located at the lower surface of the right end of the waveguide 3. The beam can propagate in the waveguide 3 from left to right, that is, the beam can propagate along the x direction as FIG. 13. Correspondingly, both the in-coupling meta-grating unit 10 and the out-coupling meta-grating unit 21 are arranged along the x direction. Under the action of the in-coupling meta-grating 1, the target beam of multiple wavelengths can propagate in the waveguide 3 at the same angle, which can effectively suppress the rainbow effect. And at the out-coupling end, the target beam of different wavelengths can be coupled from the out-coupling meta-grating 2 uniformly, which can realize the pupil reproduction and increase the eyebox range and improve the visual comfort of the human eyes.

Optionally, an AR optical system is provided, and the AR optical system includes an imaging combiner claimed as mentioned above. The image source 4 is as shown in FIG. 13. The image source is located at an incident side of the in-coupling element of the image combiner, and the image source is configured to emit at least three kinds imaging beams of the target beams to the in-coupling element. For example, the image source 4 may emit image beams comprising red, green, and blue beams, which are incident upon the in-coupling meta-grating 1. The in-coupling meta-grating 1 then couples these image beams into the waveguide 3, where they propagate. Ultimately, the image beams are coupled out by the out-coupling meta-grating 2. In this way, the observer located at the out-coupling meta-grating 2 can view the images of the image source 4.

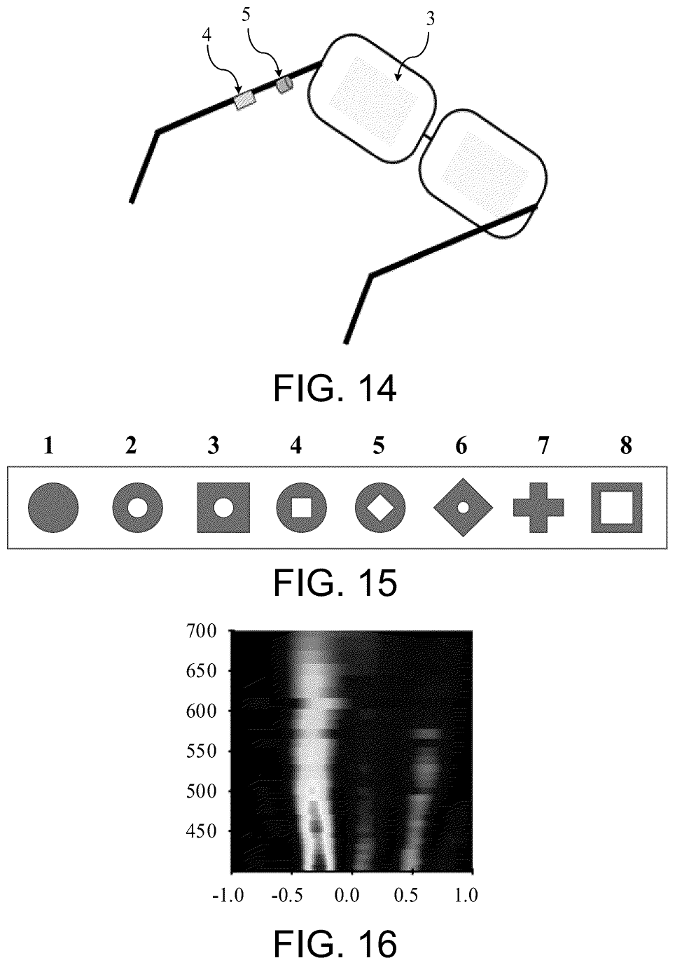

The AR optical system further includes a relay lens group. The relay lens group is located on the optical path between the imaging combiner and the image source, and the relay lens group is configured to project the target beam as 1:1, or the relay lens group is configured to magnify and project to the imaging combiner. As shown in FIG. 14, the image source 4 is set on the glasses leg of the AR glasses. The image beams emitted by the image source 4 are incident to the out-coupling element by the relay lens group. And FIG. 14 hasn't shown the out-coupling element. The lens of the AR glasses (or maybe a part of the lens) may be regarded as the waveguide 3, and the image beam may be propagated. Finally, the image beams can be coupled out by the out-coupling element, and the image beams are incident to eyes.

The structure and function of the image combiner are described in detail by one embodiment.

In the embodiment of the present application, a schematic diagram of the image combiner can be shown in FIG. 13. The RGB beams emitted by the image source are composed of light with three colors: red, green, and blue. The RGB beams are modulated by the in-coupling meta-grating 1, and are incident to the waveguide 3 with the critical angle of total reflection. The RGB beams are fully reflected within the waveguide 3 and then coupled out to be directed towards the eyes. The fundamental structure of the in-coupling meta-grating 1 is depicted in FIG. 8 and FIG. 9, while the fundamental structure of the out-coupling meta-grating 2 is illustrated in FIG. 12.

In the present embodiment, the size of the in-coupling meta-grating 1 is 10 mm×10 mm, and the thickness of the waveguide 3 is 4 mm, and the width of the waveguide 3 is 10 mm. And the length of the in-coupling meta-grating 1 may be determined based on the actual situation. For example, the length of the in-coupling meta-grating 1 may be determined based on the size of the glasses, and in general the length of the in-coupling meta-grating 1 is about 20 mm. The in-coupling meta-grating 1 includes tens of millions of in-coupling nanostructures 101, and every eight in-coupling meta-grating 101 forms an in-coupling meta-grating unit 10. That is, each in-coupling meta-grating unit 10 corresponds to eight in-coupling nanostructures 101. The eight in-coupling nanostructures 101 are in different shapes, and FIG. 15 shows a top view of an in-coupling meta-grating unit 10, and the specific shapes of the eight in-coupling nanostructures 101 are shown in FIG. 15. As shown in FIG. 15, each in-coupling nanostructure 101 is polarization-independent. And the sizes of eight in-coupling nanostructures 101 are shown in Table 1.

TABLE 1

| | 1 | 2 | 3 | 4 | 5 | 6 | 7 | 8 |
|---|---|---|---|---|---|---|---|---|
| Size 1 | 62.5 | 102.5 | 74.5 | 120 | 55.5 | 100.5 | 180 | 78 |
| Size 2 | | 60 | 35.5 | 100 | 20 | 56.5 | 30.5 | 43.5 |

In Table 1, size 1 denotes the outer dimension of nanostructure 101, such as half of its outer radius; size 2 indicates the inner dimension of nanostructure 101, for instance, half of its inner radius or the length of its inner edge. Both size 1 and size 2 are measured in millimeters (mm), with size 1 being half the cross-sectional dimension of the nanostructures (e.g., the seventh nanostructure 101 in FIG. 15). Size 2 corresponds to half the width of each cross nanostructure. The far-field electromagnetic response of the in-coupling meta-grating 1 is depicted in FIG. 16. The horizontal axis represents the sine coordinate of the reflective angle in the far-field, while the vertical axis corresponds to the wavelength.

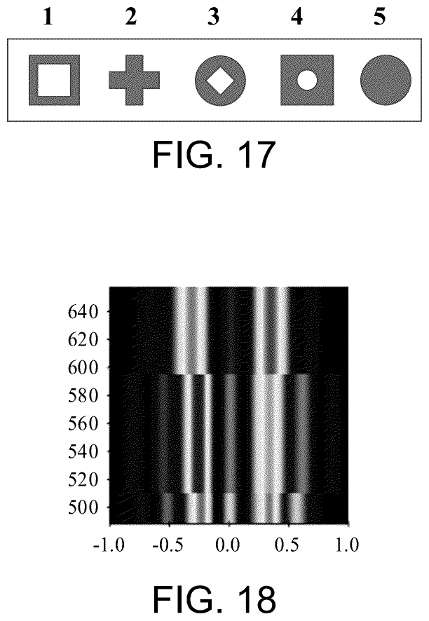

And the size of the out-coupling meta-grating 2 is 10 mm×10 mm. The out-coupling meta-grating unit 2 of the out-coupling meta-grating 2 includes five out-coupling nanostructures 211. The shapes of the five out-coupling nanostructures 211 are different. FIG. 17 shows a top view of the out-coupling meta-grating unit 21, and the specific shapes of the five out-coupling nanostructures are shown in FIG. 17. And the sizes of five out-coupling nanostructures 211 in out-coupling meta-grating unit 21 are shown in Table 2.

TABLE 2

| | 1 | 2 | 3 | 4 | 5 |
|---|---|---|---|---|---|
| Size 1 | 80 | 179 | 56 | 75 | 63.5 |
| Size 2 | 44 | 30 | 21.5 | 34.5 | |

Size 1 in Table 2 corresponds to the outer dimensions of the out-coupling nanostructure 211, such as half the outer radius of nanostructure 211. Size 2 corresponds to the inner dimensions of the out-coupling nanostructure 211, such as half the inner radius or inner edge length of nanostructure 211. Both Size 1 and Size 2 are measured in nanometers (nm). The far-field electromagnetic response of the out-coupling meta-grating 2 is depicted in FIG. 18, where the x-axis of FIG. 18 represents the sinusoidal value of the far-field refractive angle, and the y-axis represents the wavelength. The visible light is incident to the out-coupling meat-grating 2 vertically or at 25° and they are outgoing perpendicularly; for example, the perpendicularly incident environmental light and the incident target beam transmitted by the waveguide 3, thus realizing the function of mixing the virtual image with the real image.

The above is only a specific embodiment of the embodiment of this application, but the scope of protection of the embodiment of this application is not limited to this, any person familiar with the scope of the change or substitution, should be covered within the protection scope of the embodiment of this application. Therefore, the scope of the protection of the present application shall depend on the scope of the claim.

What is claimed is:

1. An in-coupling meta-grating, wherein the in-coupling meta-grating comprises: a plurality of in-coupling grating units; and the plurality of in-coupling grating units are arranged in a period,
wherein the in-coupling grating units are configured to modulate a variety of incident target beams, and the variety of incident target beams passes through the in-coupling unit at corresponding target diffraction orders with the same outgoing angle,
wherein the variety of target beams have different wavelengths, and the target diffraction orders are the diffraction orders of the outgoing target beams modulated by the in-coupling meta-grating.

2. The in-coupling meta-grating of claim 1, wherein the plurality of in-coupling grating units is configured to modulate the variety of target beams with the same incident angles,
wherein the variety of target beams corresponds to a variety of target diffraction orders.

3. The in-coupling meta-grating of claim 2, wherein a period of the in-coupling meta-grating unit is configured to make a wavelength of the target beam negatively correlated with the corresponding target diffraction orders.

4. The in-coupling meta-grating of claim 1, wherein the in-coupling grating unit is configured to modulate the variety of incident target beams, and the variety of incident beams are incident to the in-coupling meta-grating with a variety of incident angles.

5. The in-coupling meta-grating of claim 1, wherein the variety of target diffraction orders comprises a first target diffraction order and a second target diffraction order,
wherein a variety of first outgoing angles of the variety of target beams at the first target diffraction order are the same, and the variety of first outgoing angles of the variety of target beams at the second target diffraction order are the same,
wherein the first outgoing angle and the second outgoing angle deflect to a variety of arrangement directions of the in-coupling grating unit.

6. The in-coupling meta-grating of claim 1, wherein the in-coupling grating unit is configured to modulate the variety of target beams which are perpendicularly incident to the in-coupling meta-grating.

7. The in-coupling meta-grating of claim 1, wherein the variety of target beams comprises a red waveband beam, a green waveband beam and a blue waveband beam.

8. The in-coupling meta-grating of claim 1, wherein the in-coupling grating unit comprises a plurality of in-coupling nanostructures, and the plurality of in-coupling nanostructures are arranged in a line,
wherein at least a part of the in-coupling nanostructures are in different shapes.

9. The in-coupling meta-grating of claim 8, wherein the in-coupling nanostructures are determined by maximizing the minimum diffraction efficiency, and the minimum diffraction efficiency is the lowest value among the diffraction efficiencies of all the target beams.

10. An out-coupling meta-grating, wherein the out-coupling meta-grating comprises: a plurality of out-coupling regions arranged in order along a preset direction, and the out-coupling regions comprise a plurality of out-coupling meta-grating units,
wherein each out-coupling meta-grating unit is configured to couple out the variety of target beams, and the variety of target beams are incident to the out-coupling meta-grating unit at the same incident angle,
wherein the variety of target beams propagate along the preset direction, and the diffraction efficiency of the plurality of out-coupling regions arranged in order increases progressively.

11. The in-coupling meta-grating of claim 10, wherein the diffraction efficiency of the out-coupling regions satisfies:
$$eff ( n ) = \frac{1}{( N - n + 1 )} ;$$
wherein, eff(n) is the diffraction efficiency of a nₜₕ out-coupling region arranged along the preset direction, and N is a number of all the out-coupling regions.

12. The in-coupling meta-grating of claim 10, wherein the out-coupling meta-grating unit comprises a plurality of out-coupling nanostructures arranged in a line along the length direction of the out-coupling meta-grating unit,
wherein at least a part of the plurality of out-coupling nanostructures are in different shapes.

13. The in-coupling meta-grating of claim 12, wherein the out-coupling nanostructures in each out-coupling region obtained by maximizing a target function, and the target function satisfies:
$${F}_{i} ( n ) = \{ \begin{matrix}min ( \frac{{\vert {t}_{{m}_{i}} ( n ) \vert}^{2}}{Eff ( n )} , \frac{{\vert {r}_{{0}_{i}} ( n ) \vert}^{2}}{1 - Eff ( n )} ) , n < N \\ {\vert {t}_{{m}_{i}} ( n ) \vert}^{2} , n = N\end{matrix} ;$$
wherein Fᵢ(n) is the diffraction efficiency of a nₜₕ out-coupling region for an iₜₕ target beam arranged along the preset direction; tₘ_{ᵢ}(n) is a diffraction light intensity of the nₜₕ out-coupling region for the iₜₕ target beam; r₀_{ᵢ}(n) is a reflective light intensity of the nₜₕ out-coupling region for the iₜₕ target beam; Eff(n) is a theoretical diffraction efficiency of a nₜₕ out-coupling region;
N is a number of all out-coupling regions.

14. An imaging combiner, wherein the imaging combiner comprises an in-coupling element, a waveguide, and an out-coupling element; the in-coupling element is located at an in-coupling end of the waveguide, and the out-coupling element is located at an out-coupling end of the waveguide,
wherein the plurality of in-coupling meta-grating units of the in-coupling meta-grating are arranged along a first direction, and the plurality of out-coupling meta-grating units of the out-coupling meta-grating are arranged along the first direction,
wherein the first direction is from the in-coupling end of the waveguide to the out-coupling end of the waveguide.

15. The imaging combiner of claim 14, wherein the in-coupling meta-grating comprises:
a plurality of in-coupling grating units; and the plurality of in-coupling grating units are arranged in a period, wherein the in-coupling grating units are configured to modulate a variety of incident target beams, and the variety of incident target beams passes through the in-coupling unit at corresponding target diffraction orders with the same outgoing angle, wherein the variety of target beams have different wavelengths, and the target diffraction orders are the diffraction orders of the outgoing target beams modulated by the in-coupling meta-grating,
wherein the out-coupling meta-grating comprises:
a plurality of out-coupling regions arranged in order along a preset direction, and the out-coupling regions comprise a plurality of out-coupling meta-grating units, wherein each out-coupling meta-grating unit is configured to couple out the variety of target beams, and the variety of target beams are incident to the out-coupling meta-grating unit at the same incident angle, wherein the variety of target beams propagate along the preset direction, and the diffraction efficiency of the plurality of out-coupling regions arranged in order increases progressively.

16. The imaging combiner of claim 15, wherein the in-coupling meta-grating comprises:
a plurality of in-coupling grating units; and the plurality of in-coupling grating units are arranged in a period, wherein the in-coupling grating units are configured to modulate a variety of incident target beams, and the variety of incident target beams passes through the in-coupling unit at corresponding target diffraction orders with the same outgoing angle, wherein the variety of target beams have different wavelengths, and the target diffraction orders are the diffraction orders of the outgoing target beams modulated by the in-coupling meta-grating.

17. The imaging combiner of claim 15, wherein the out-coupling meta-grating comprises:
a plurality of out-coupling regions arranged in order along a preset direction, and the out-coupling regions comprise a plurality of out-coupling meta-grating units, wherein each out-coupling meta-grating unit is configured to couple out the variety of target beams, and the variety of target beams are incident to the out-coupling meta-grating unit at the same incident angle, wherein the variety of target beams propagate along the preset direction, and the diffraction efficiency of the plurality of out-coupling regions arranged in order increases progressively.

18. An AR optical system, wherein the AR optical system comprises an imaging combiner claimed as claim 14, an image source and a relay lens group,
wherein the image source is located at an incident side of the in-coupling element of the image combiner, and the image source is configured to emit at least three kinds of imaging beams of the target beams to the in-coupling element.

19. The AR optical system of claim 16, the relay lens group is located on the optical path between the imaging combiner and the image source, and the relay lens group is configured to project the target beam as 1:1.

20. The AR optical system of claim 16, the relay lens group is located on the optical path between the imaging combiner and the image source, and the relay lens group is configured to magnify and project to the imaging combiner.
